(19) United States
(12) Patent Application Publication
(10) Pub. No.: US 2005/0162474 A1
(43) Pub. Date: Jul. 28, 2005

(54) Head chip for inkjet printers and method thereof

(76) Inventor: Eun-bong Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/946,120

(22) Filed: Sep. 22, 2004

(30) Foreign Application Priority Data
Jan. 28, 2004 (KR) 2004-5416

(51) Int. Cl. B41J 2/14; B41J 2/16

(52) U.S. Cl. 347/50

(57) ABSTRACT

A head chip for inkjet printers and a method thereof are provided. The head chip has a semiconductor substrate provided with heating elements and pads for applying electric power to the heating elements, and has first Metal Oxide Semiconductors (MOSs) formed in the semiconductor substrate, wherein the first MOSs are formed in the semiconductor substrate and in semiconductors heterogeneous with respect to the semiconductor substrate, and semiconductor wells homogeneous with respect to the first MOSs are formed in the semiconductor substrate in direction of wires connected to the pads.

### CROSS-REFERENCE TO RELATED APPLICATIONS

This application claims the benefit under 35 U.S.C. § 119(a) of Korean Patent Application No. 2004-5416, filed on Jan. 28, 2004, the entire contents of which are incorporated herein by reference.

### BACKGROUND OF THE INVENTION

1. Field of the Invention

The present invention relates to a head chip for inkjet printers and a method thereof. More particularly, the present invention relates to a head chip for inkjet printers capable of preventing an electric short circuit in the head chip provided in the inkjet printers and a method thereof.

2. Description of the Related Art

In general, an inkjet printer heats ink, and ejects the heated ink onto paper, to thereby form images. The larger the number of nozzles firing ink, the faster the image-forming and the better the image quality. Thus, many 600 dpi-class inkjet printers and 1200-dpi class inkjet printers have emerged on the market. Signal lines for controlling individual nozzles are arranged to individual nozzles, and as logic circuits for controlling the signal lines become larger in size, the signal lines and logic circuits have become integrated into a circuit. In general, such an integrated circuit (IC) is referred to as a head chip, and, with the increase of the number of logic circuits and signal lines that are integrated in a head chip, more electric short circuits occur in the head chip.

FIG. 1 is a perspective view for showing a general ink cartridge for inkjet printers. Referring to FIG. 1, the ink cartridge is provided with a flexible printed circuit (FPC) board 10, FPC connectors 11, and a head chip 20.

The FPC board 10 transmits signals and electric power between the body of an inkjet printer (not shown) and the head chip 20 through the FPC connectors 11. Channels are formed between the FPC connectors 11 and the head chip 20 to supply ink to the head chip 20, and the head chip 20 fires ink according to signals that are received from the body through the FPC connectors 11. The ink cartridge is mounted in the inkjet printer. The ink cartridge when printing moves in the direction perpendicular to the direction in which paper is supplied.

The head chip consists of channels and heaters for heating the ink in order to fire it, together with logic circuits for serial communications with the body and a driver logic circuit formed of a Metal Oxide Semiconductor Field Effect Transistor (MOSFET) for driving the heaters, in order to reduce the number of signal lines connected to the body. Such a head chip has nozzles arranged in 600 dots per inch (dpi) or 1200 dpi in general, but there is no or little need to use the fine machinery process since the chip becomes larger in size as the number of nozzles increases. Thus, in order to lower chip production costs, the simplest Complementary Metal Oxide Semiconductor (CMOS) manufacturing process is applied when the inkjet head chip is designed.

FIG. 2 is a cross-sectioned view for schematically illustrating a structure of an FET portion of a head chip using a P-type substrate. Referring to FIG. 2, the FET portion of the head chip has a low-voltage logic FET and a high-voltage FET for driving the heater on the P-type substrate, together with a pad 21 for applying electric power to heating elements (not shown).

The P-type substrate can have Negative-channel Metal Oxide Semiconductors (NMOSs) of heterogeneous type and PMOSs of homogeneous type therein. The homogeneous Positive-channel Metal Oxide Semiconductor (PMOSs) are formed in a semiconductor well (N-well) 23 of heterogeneous type. Such a head chip is coupled to the FPC board 10 of the ink cartridge, and mounted in a print system, for printing.

FIG. 3 is a view for schematically illustrating the FPC board of FIG. 1. Referring to FIG. 3, the FPC board provides signals and electric power between the printer body and the head chip 20, and, in order to couple the FPC board with the head chip 20, a specific length of the insulator covering the FPC board is removed, and leads of the FPC board are connected on the pad 21 of the head chip 20, whereas, on the other end of the FPC board, connectors 11-1 and 11-2 are formed so that the FPC board can electrically connect to the printer body.

FIG. 4 is a cross-sectioned view for schematically showing a junction portion connecting the head chip of FIG. 2 and the ink cartridge. Referring to FIG. 4, when the head chip 20 of a general inkjet printer is coupled with the FPC board 10 for supplying electric power and signals to the body of an ink cartridge, the lead portion of the FPC board 10 is directly coupled with the pad 21 of the chip 20 by ultrasonic bonding, thermal bonding, or the like, using tape automatic bonding (TAB) rather than wire bonding which is typically employed, the pad 21 is shielded using a capsulation bond 15, and die bond 30 is employed to bond the FPC board to the ink cartridge.

Further, the printer system performs operations for keeping the head chip 20 clean, such as wiping, capping, and so on, by use of the wiper 40, in order to remove the residual ink on the surface of the head chip 20 and to prevent the openings of the nozzles from being clogged before, after, or during printing. A problem occurs that frequent wiping exerts pressure on the capsulation bond 15 of the head chip 20 and the FPC board 10 so that the lead portion of the FPC board 10 touches the edge portion of the chip 20.

FIG. 5 is a view for showing the modeling of a diode for the head chip of FIG. 4. As described above, when the FPC lead 13 of the chip 20 that has been formed by dicing in the wafer is in contact with partially damaged portions of insulation layers or exposed edge portions of a substrate, a diode is formed in a structure between the P-type substrate and the source of the NMOS 24 connected to the ground. That is, when a voltage is applied to the exposed substrate portion, the voltage causes a leakage current to flow through a current path formed between the P-type substrate and the source of the NMOS 24. The threshold voltage of the NMOS 24 varies, which causes the NMOS 24 to malfunction, and the insulation layer formed between the P-type substrate and the gate of the NMOS 24 is destroyed depending on the magnitude of the voltage applied to the P-type substrate, which causes the NMOS 24 to malfunction. Further, the voltage applied to the P-type substrate causes the potential of the P-type substrate to be unstable, and can cause the PMOS 25 formed on the P-type substrate to malfunction. That is, the conventional head chip has a problem of causing the head chip 20 to malfunction since it can form diodes in the forward direction in a structure between the substrate and the FET logic circuits or the sources of the heater-driving transistors that are provided in the head chip, and cause the leakage current i1 to flow through the ground terminal for electrical power that is connected to the sources.

### SUMMARY OF THE INVENTION

The present invention has been developed in order to solve the above drawbacks and other problems associated with the conventional arrangement. An aspect of the present invention is to provide a head chip for inkjet printers capable of preventing electric short circuits in the head chip that is provided in inkjet printers and a method thereof.

The forgoing and other objects and advantages are substantially realized by providing a head chip for inkjet printers and a method thereof. The head chip and method comprise a semiconductor substrate provided with heating elements and pads for applying electric power to the heating elements, and having first Metal Oxides (MOSs) formed in the semiconductor substrate, wherein the first MOSs are formed in the semiconductor substrate and in semiconductors heterogeneous with respect to the semiconductor substrate, and semiconductor wells homogeneous with respect to the first MOSs are formed in the semiconductor substrate in a direction of wires connected to the pads.

Second MOSs heterogeneous with respect to the first MOSs are preferably formed in the semiconductor substrate.

The second MOSs are preferably formed in the semiconductor wells heterogeneous with respect to the semiconductor substrate.

Preferably, when voltages from the wires are applied to the semiconductor wells, diodes are formed in a structure in a reverse direction, the reverse direction being a direction from the semiconductor wells to the semiconductor substrate.

Preferably, when voltages from the wires are applied to the semiconductor wells, diodes are formed in a structure in a forward direction, the forward direction being a direction from the semiconductor substrate to the first MOSs.

The first MOSs are preferably Negative-channel Metal Oxide Semiconductor (NMOS)-type transistors.

Therefore, the head chip for inkjet printers according to an embodiment of the present invention can prevent electric short circuits therein even if the FPC lead is in contact with edge portions of the head chip.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view illustrating a general ink cartridge for inkjet printers;

FIG. 2 is a view schematically illustrating a Field Effect Transistor (FET) structure of an inkjet head using a P-type substrate;

FIG. 3 is a view schematically illustrating the FPC shown in FIG. 1;

FIG. 4 is a view illustrating the coupling of the head chip of FIG. 2 and the ink cartridge;

FIG. 5 is a view illustrating an example of a diode resulting from a defective in the head chip shown in FIG. 4; and

FIG. 6 is a view illustrating a head chip for inkjet printers according to an embodiment of the present invention.

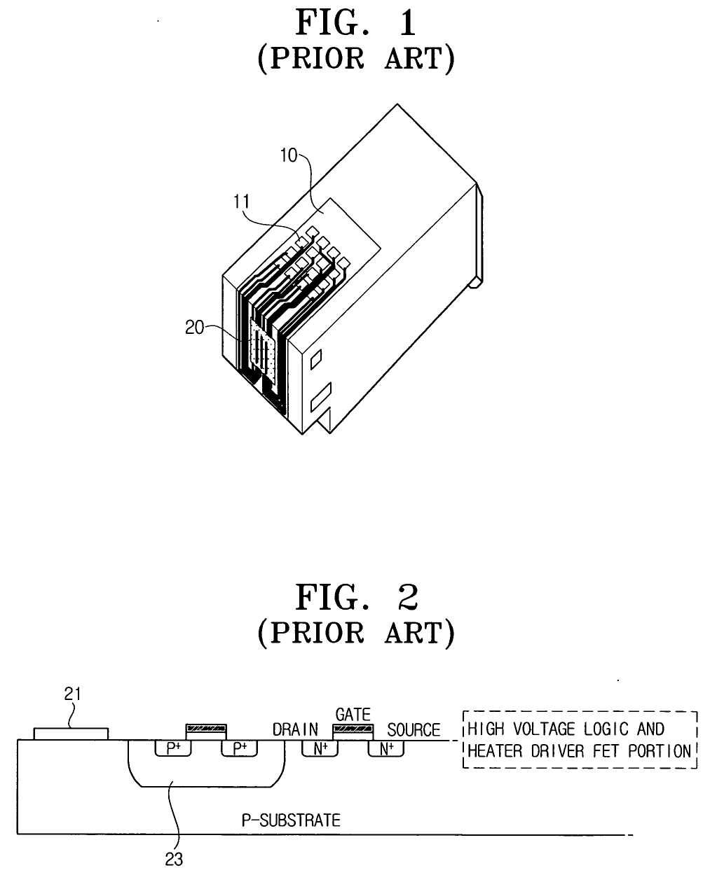

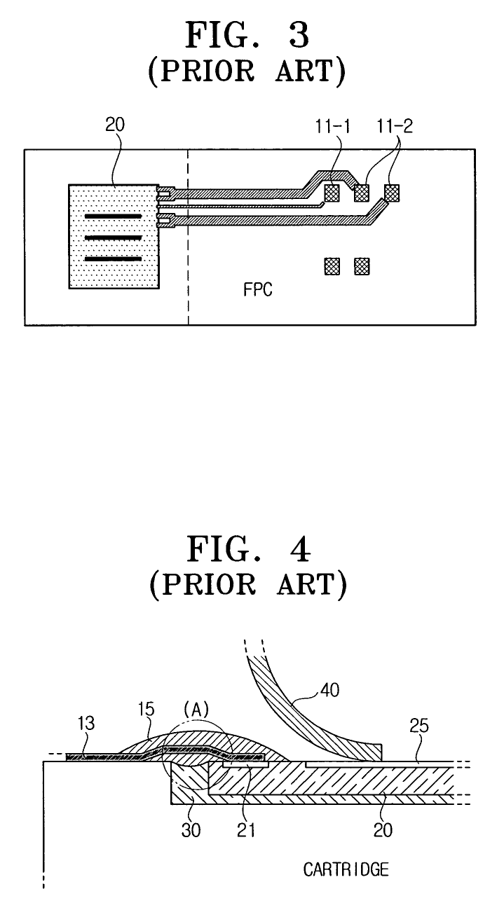

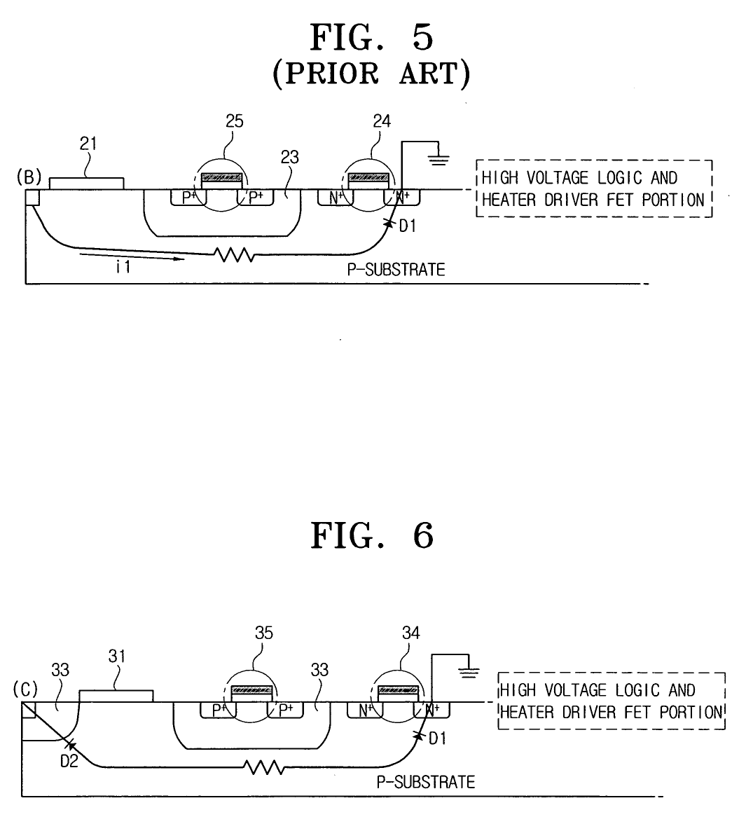

Throughout the drawings, it should be noted that the same or similar elements are denoted by like reference numerals.

### DETAILED DESCRIPTION OF THE PREFERRED EMBODIMENTS

Hereinafter, a head chip for inkjet printers according to an embodiment of the present invention will be described in detail with reference to the accompanying drawings.

FIG. 6 is a view schematically illustrating a head chip for inkjet printers according to an embodiment of the present invention. A description will be made based on the assumption that the P-type substrate is used for the inkjet printer head chip. The P-type substrate can have Negative-channel Metal Oxide Semiconductors (NMOSs) of a heterogeneous type and Positive-channel Metal Oxide Semiconductors (PMOSs) of a homogeneous type thereon. The homogeneous PMOSs are formed in a heterogeneous semiconductor well (N-well) 23.

The head chip shown comprises pads 31 to which a flexible printed circuit (FPC) cable is coupled, driver logic circuits, logic circuits for serial communications, and various logic circuits such as decoders and the like, and such components for the head chip are mainly integrated into NMOSs or PMOSs. Such integrated NMOS and PMOS can be schematically illustrated as an NMOS 34 and a PMOS 35 as shown in FIG. 6. That is, the NMOS 34 and PMOS 35 shown in FIG. 6 represent NMOSs and PMOSs, respectively, comprising various logic circuits that can be provided in the head chip, such as head driver logic circuits for controlling electrical power applied from the main body of an inkjet printer, head logic circuits for decoding a print signal supplied from the body of the inkjet printer, and the like.

Further, when a wire is in contact with the pad 31 formed on the P-type substrate, an N-type well 33 is preferably formed in the direction in which the wire is contacted, that is, in the portion C on the left side of the pad 31, being a heterogeneous type with respect to the P-type substrate. The P-type substrate formed in the portion C and the N-type well 33 heterogeneous with respect to the substrate form a diode in a reverse direction, that is, in the direction from the well 33 to the semiconductor substrate, if a voltage is applied from the connected wire to the semiconductor well 33. Further, the P-type substrate and the NMOS 34 are heterogeneous with respect to the substrate and form a diode D1 in a forward direction, that is, in the direction from the P-type substrate to the NMOS, if a voltage is supplied from the wire connected to the pad 31 to the semiconductor well 33. Thus, leakage currents can be prevented from flowing into the NMOS even if the FPC lead is in contact with the edge portions of the head chip 20 due to damage to the inkjet printer head chip 20.

The inkjet printer head chip according to an embodiment of the present invention prevents leakage currents from flowing into MOS transistors even if wires or leads connected to pads are in contact with the edge portions of the head chip due to damages to the head chip, so as to prevent electrical short circuits as well as be protected from the damage caused by electrical short circuits.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations should be apparent to those skilled in the art.

1. A head chip for inkjet printers having a semiconductor substrate comprising:
heating elements;
pads for applying electrical power to the heating elements, said pads having first Metal Oxide Semiconductors (MOSs) formed in the semiconductor substrate, wherein the first MOSs are formed in the semiconductor substrate and in semiconductors heterogeneous with respect to the semiconductor substrate, and semiconductor wells homogeneous with respect to the first MOSs are formed in the semiconductor substrate in a direction of wires connected to the pads.

2. The head chip as claimed in claim 1, wherein second MOSs heterogeneous with respect to the first MOSs are formed in the semiconductor substrate.

3. The head chip as claimed in claim 2, wherein the second MOSs are formed in the semiconductor wells heterogeneous with respect to the semiconductor substrate.

4. The head chip as claimed in claim 1, wherein, when voltages from the wires are applied to the semiconductor wells, diodes are formed in a structure in a reverse direction, the reverse direction being a direction from the semiconductor wells to the semiconductor substrate.

5. The head chip as claimed in claim 1, wherein, when voltages from the wires are applied to the semiconductor wells, diodes are formed in a structure in a forward direction, the forward direction being a direction from the semiconductor substrate to the first MOSs.

6. The head chip as claimed in claim 1, wherein the first MOSs comprise Negative-channel Metal Oxide Semiconductors (NMOS)-type transistors.

7. A method of preventing electrical short circuits in a head chip for inkjet printers having a semiconductor substrate, the method comprising:
applying electrical power to heating elements via pads, said pads having first Metal Oxide Semiconductors (MOSs) formed in the semiconductor substrate, wherein the first MOSs are formed in the semiconductor substrate and in semiconductors heterogeneous with respect to the semiconductor substrate, and semiconductor wells homogeneous with respect to the first MOSs are formed in the semiconductor substrate in a direction of wires connected to the pads.

8. The method as claimed in claim 7, comprising:
forming second MOSs heterogeneous with respect to the first MOSs in the semiconductor substrate.

9. The method as claimed in claim 8, wherein the second MOSs are formed in the semiconductor wells heterogeneous with respect to the semiconductor substrate.

10. The method as claimed in claim 7, wherein the step of applying electrical power further comprises:
forming diodes in a structure in a reverse direction.

11. The method as claimed in claim 10, the reverse direction being a direction from the semiconductor wells to the semiconductor substrate.

12. The method as claimed in claim 7, wherein the step of applying electrical power further comprises:
forming diodes in a structure in a forward direction.

13. The method as claimed in claim 12, the forward direction being a direction from the semiconductor substrate to the first MOSs.

14. The method as claimed in claim 7, wherein the first MOSs comprise Negative-channel Metal Oxide Semiconductors (NMOS)-type transistors.
